(19) United States
(12) Patent Application Publication
(10) Pub. No.: US 2026/0004168 A1
(43) Pub. Date: Jan. 1, 2026

(54) SYSTEM INTEGRATING ARTIFICIAL INTELLIGENCE MACHINE LEARNING INFERENCE AGENT AND RADIO ACCESS NETWORK UNIT

(71) Applicant: Intel Corporation, Santa Clara, CA (US)

(72) Inventors: Meng ZHANG, Shanghai (CN); Di LIU, Shanghai (CN); Jinwei FAN, Shanghai (CN); Chuyue ZHANG, Shanghai (CN)

(21) Appl. No.: 19/332,785

(22) Filed: Sep. 18, 2025

(30) Foreign Application Priority Data
Aug. 15, 2025 (WO) PCTCN2025114945

(51) Int. Cl. G06N 5/04

(52) U.S. Cl. CPC G06N 5/04

(57) ABSTRACT

The disclosure described herein generally relates to a system integrating Radio Access Network (RAN) with Artificial Intelligence and Machine Learning (AI/ML) inference agent and, more particularly, to the use of a system integrating an AI/ML inference agent and a RAN unit. The system is software defined, involving model operations such as model inference, model update and model fallback or backup in a real-time system. The inference performance is maintained without training new data from outer resources. It brings no additional cost when updating the model within inner-loop and fallback or backup decision is also within inner-loop without additional resources.

### RELATED APPLICATION

This application claims the benefit of priority to Patent Cooperation Treaty (PCT) Application No. PCT/CN2025/114945, filed Aug. 15, 2025. The entire content of that application is incorporated by reference in its entirety.

### BACKGROUND

The evolution toward intelligent Radio Access Network (RAN) drives the need to integrate Artificial Intelligence and Machine Learning (AI/ML) into RAN. The implementation of AI/ML requires significant computational investment. Incorporating AI/ML into RAN goes beyond mere wireless performance optimization. It requires careful coordination between wireless performance, computational efficiency and AI/ML model accuracy. This necessitates operating under competing constraints from these dimensions. Consequently, minimizing computational costs while maintaining effectiveness has become an increasingly critical objective.

### BRIEF DESCRIPTION OF THE DRAWINGS

FIG. 1 is a schematic diagram illustrating an example system.

FIG. 2 is a schematic diagram illustrating an example process for inner-loop operations.

FIG. 3 is a schematic diagram illustrating an example process for inner-loop and outer-loop operations.

FIG. 4 is a schematic diagram illustrating another example system.

FIG. 5 is a schematic diagram illustrating yet another example system.

FIG. 6 is a schematic diagram illustrating another example process for inner-loop and outer-loop operations.

FIG. 7 is a schematic diagram illustrating an example workflow for inner-loop operations.

FIG. 8 is a schematic diagram illustrating an example workflow for inner-loop and outer-loop operations.

FIG. 9 is a schematic diagram illustrating an example process for local operations and cloud operations.

FIG. 10 illustrates an example of a logic flow.

FIG. 11 illustrates another example of a logic flow.

FIG. 12 illustrates yet another example of a logic flow.

FIG. 13 illustrates an example of a logic flow.

### DETAILED DESCRIPTION

In the following description, numerous specific details are set forth in order to provide a thorough understanding of the present disclosure. However, it will be apparent to those skilled in the art that the implementations of the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring the disclosure.

The accompanying drawings, which are incorporated herein and form a part of the specification, illustrate the present disclosure and, together with the description, further serve to explain the principles and to enable a person skilled in the pertinent art to make and use the techniques discussed herein. In the drawings, like reference characters generally refer to the same parts throughout the different views. The drawings are not necessarily to scale, emphasis instead generally being placed upon illustrating the principles of the disclosure.

The present disclosure will be described with reference to the accompanying drawings. The drawing in which an element first appears is typically indicated by the leftmost digit(s) in the corresponding reference number.

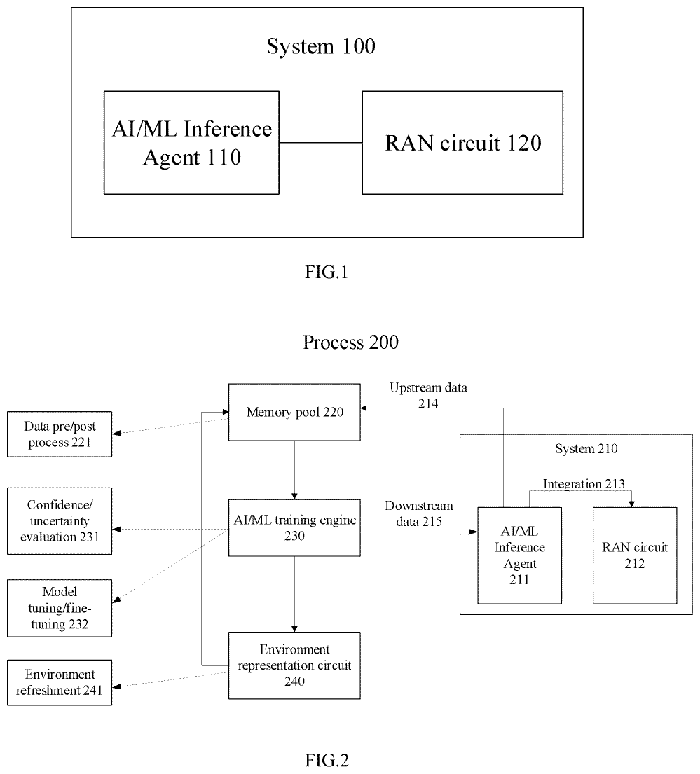

FIG. 1 is a schematic diagram illustrating an example system 100. In some examples, as shown in FIG. 1, the system 100 may include an Artificial Intelligence and Machine Learning (AI/ML) inference agent 110 and a Radio Access Network (RAN) circuit 120. The RAN circuit 120 may be a software defined RAN. The AI/ML inference agent 110 may be a software defined AI/ML inference agent. The RAN circuit 120 may be a real-time RAN. The system 100 may be a real-time system integrating the AI/ML inference agent 110 and the RAN circuit 120. In some examples, the AI/ML inference agent 110 may be integrated in the RAN circuit 120.

In some examples, hardware used for computing may be shared between the AI/ML inference agent 110 and the RAN circuit 120. The hardware may include CPU cores. Computing tasks may be carried out within inner-loop in the system 100. The computing tasks may include model update, model fallback or backup and so forth. Models may include machine learning models such as reinforcement learning models. In an inner-loop, only computing resources in the CPU domain are involved for compute. The system 100 may be deployed in the same set of CPU hardware as used for the inner-loop. Inner-loop refers to latency-critical computing tasks executed in RAN's physical layer, entirely consuming computing resources for real-time radio control. In some examples, the AI/ML inference agent 110 may host lightweight Machine Learning (ML) models locally for inner-loop tasks. The AI/ML inference agent 110 may embed lightweight models directly within the RAN circuit 120. The size of the model may be 1 MB and smaller. The model size may be dynamically adjusted according to the specific use environment. Performance of the model may be well justified on the reasonably sized models on CPU.

FIG. 2 is a schematic diagram illustrating an example process for inner-loop operations. As shown in FIG. 2, process 200 may be an example real-time process for inner-loop operations. The inner-loop operations may include model update, model fallback or backup, and so forth.

An example system 210 is shown in FIG. 2. The system 210 may include an AI/ML inference agent 211 and a RAN circuit 212. The RAN circuit 212 may be a software defined RAN. The AI/ML inference agent 211 may be a software defined AI/ML inference agent. The RAN circuit 212 may be a real-time RAN. The system 210 may be a real-time system integrating the AI/ML inference agent 211 and the RAN circuit 212. In some examples, integration 213 may be carried out on the AI/ML inference agent 211, and the AI/ML inference agent 211 may be integrated in the RAN circuit 212.

In some examples, the AI/ML inference agent 211 and the RAN circuit 212 may be in an interface mode, where they may be coupled to each other via an interface. The interface may include gRPC/eBPF interface. The gRPC Remote Procedure Calls (gRPC) and the extended Berkeley Packet Filter (eBPF) may be real-time interaction interfaces. Real-time interaction may be performed between the inference agent 211 and the RAN circuit 212 via the real-time interaction interface. The gRPC/eBPF interfaces may be exposed to real-time software. The gRPC is an open-source high-performance RPC framework used for real-time communication between software components. It may enable low-latency, bidirectional data streaming with strong interface contracts. In 5G RAN systems, for example, it may provide standardized real-time interfaces for control-plane interactions. Its sub-millisecond latency may support time-sensitive RAN operations. The gRPC may enable efficient communication between distributed services across multiple languages and platforms, making it suitable for microservices architectures and low-latency network scenarios. The eBPF may be a revolutionary in-kernel virtual machine technology that allows sandboxed programs to run within the Linux kernel without modifying kernel source code or loading kernel modules. It may extend the original Berkeley Packet Filter (BPF) to provide capabilities for safe, event-driven execution in privileged contexts, enabling dynamic tracing, network packet filtering, performance monitoring, and security enforcement.

In some examples, the AI/ML inference agent 211 and the RAN circuit 212 may be in a shared-memory mode. In the shared-memory mode, the AI/ML inference agent 211 and the RAN circuit 212 may access the same physical memory space via hardware-assisted mapping. They may communicate through memory-resident data structures and synchronize using atomic CPU instructions.

In some examples, hardware used for computing may be shared between the AI/ML inference agent 211 and the RAN circuit 212. The hardware may include CPU cores. Computing tasks may be carried out within inner-loop in the system 210. The computing tasks may include model update, model fallback or backup, and so forth. Models may include machine learning models such as reinforcement learning models. In an inner-loop, only computing resources in the CPU domain are involved for compute. The system 210 may be deployed in the same set of CPU hardware as used for the inner-loop. Inner-loop refers to latency-critical computing tasks executed in RAN's physical layer, entirely consuming computing resources for real-time radio control. In some examples, the AI/ML inference agent 211 may host lightweight Machine Learning (ML) models locally for inner-loop tasks. The AI/ML inference agent 211 may embed lightweight models directly within the RAN circuit 212. The size of the model may be 1 MB and smaller. The model size can be dynamically adjusted according to the specific use environment. Performance of the model may be well justified on the reasonably sized models on CPU.

Apart from the system 210, a memory pool 220, an AI/ML training engine 230 and an environment representation circuit 240 are shown in FIG. 2. The memory pool 220 and an AI/ML training engine 230 may be communicatively coupled to the AI/ML inference agent 211. The memory pool 220 may be communicatively coupled to the AI/ML training engine 230 and the environment representation circuit 240. The AI/ML training engine 230 may be communicatively coupled to the environment representation circuit 240. As shown in FIG. 2, the memory pool 220 is further configured for data pre/post process 221. The AI/ML training engine 230 is further configured for confidence/uncertainty evaluation 231 and model tuning/fine tuning 232. The environment representation circuit 240 is further configured for environment refreshment 241.

In some examples, inner-loop operations may include AI/ML model inference and model update. The inner-loop operations can be task-based, as multiple tasks can be carried out on a single hardware (e.g. CPU core). The inner-loop typically handles high-frequency disturbances while the outer-loop manages slower setpoint adjustments.

In some examples, as shown in FIG. 2, upstream data 214 may be forwarded to the memory pool 220 by the AI/ML inference agent 211. The upstream data 214 may include data such as raw data, intermediate results, generated by a core network or a user equipment (UE). The memory pool 220 may allocate buffer for data preprocessing. Then the upstream data 214 may be forwarded to the AI/ML training engine 230. The AI/ML training engine 230 may perform confidence/uncertainty evaluation 231 and model tuning/fine tuning 232. The AI/ML training engine 230 may enable the environment representation circuit 240 to refresh the environment. Then information involving the environment refreshment 241 may be forwarded to the memory pool 220. The memory pool 220 may allocate buffer for data postprocessing. Processed data may be included in the downstream data 215. The downstream data 215 may be forwarded to the AI/ML inference agent 211. The memory pool 220 may be used to optimize memory allocation and management.

In some examples, model operations may include model inference, model update, model fallback or backup. Model update may include parameters (e.g., weights and bias) update. For example, when the model update is to be carried out in the system 210, resources for AI/ML model update are with the inner-loop based on CPU. Model update may use the same CPU resources set as RAN software workload. Inner-loop allows fast model modification, for example, the parameters modification. The inner-loop also allows multiple task-based operations in the CPU core. Only computing resources in the CPU domain are involved in updating the model parameter, where no outer computing resources are required from outside the CPU hardware.

In some examples, prior to forwarding the upstream data 214 by the AI/ML inference agent 211, the process 200 may further include operations by a UE. For example, a UE may initiate a request such as a PDU session establishment request, where the request may be included in uplink data. The PDU may refer to the Protocol Data circuit. The PDU Session may refer to the logical connection between a UE and a specific Data Network (DN), such as the Internet, an enterprise LAN. After activation of the PDU Session, the UE may send uplink data encapsulating service upload. The uplink data may refer to the upstream data 214. The RAN circuit may forward this uplink data to the user plane function (UPF) through GTP-U tunnel over N3 interface. The UPF may route decapsulated IP packets to the data network via an N6 interface. The memory pool resides in the DN. The N3 interface may refer to a reference interface between the RAN and the UPF. The N6 interface may refer to a reference point between the UPF in the 5G core and the external data network (e.g., the public Internet, a private enterprise network). The GTP-U tunnel may be a concrete user-plane construct that rides over N3 to deliver the subscriber's data.

In some examples, a fallback or backup may be executed by the AI/ML inference agent 211 when a first condition is met. The model fallback or backup may be based on inner-loop feedback. The feedback may include measurements, throughput, channel conditions, and so forth. The measurements may include predicted mutual information per bit (PMIB). The PMIB quantifies how much information a transmitted bit retains after battling noise, interference, and fading. Its scale runs from 0 (chaos) to 1 (perfect clarity). For example, the PMIB at a value of 0.7 means 70% of the bit's “soul” survives the channel's onslaught. The PMIB may illustrate the prediction performance of the AI/ML inference agent 211.

For example, the first condition may include the PMIB to fall below a predetermined threshold. When the PMIB fails to satisfy a threshold, a fallback or backup execution may be triggered. The AI/ML inference agent 211 may execute the model fallback or backup. In a first inner-loop, the AI/ML inference agent 211 monitors the PMIB and finds the PMIB to fall below a predetermined threshold. Then a fallback or backup decision is made by the AI/ML inference agent 211 within the first inner-loop.

Consequently, a second inner-loop is triggered. In some examples, the inner-loops may operate iteratively, executing its computational routine while the AI/ML inference agent 211 monitors prediction performance metrics such as the PMIB. Should the prediction performance metrics fail to meet predefined convergence criteria or a threshold, the loop initiates another computation cycle. This process repeats autonomously until the convergence criteria is met or the threshold is satisfied. In some examples, the inference agent records on trained model, weights and bias version and performance evaluation criteria.

Model updates may be transmitted as structured messages. The messages may contain neural network layer details. Layer information may include weights and biases of the model. The model parameter transactions through messages may also work for reinforcement learning models. The message may include information about the model updates. In some examples, the message may be implemented as a JSON message. Specifically, a JavaScript Object Notation (JSON) file may be used to describe details of the model updates. JSON is an open standard file format and data interchange format that uses human-readable text to store and transmit data objects consisting of attribute-value pairs and arrays (or other serializable values). It is a language-independent data format derived from JavaScript. JSON may be employed for transmitting data in web applications and storing configuration settings. The JSON file may serve as a standardized, machine-parsable format to precisely define and transmit network configuration parameters. It may enable efficient representation of complex hierarchical network settings, facilitating their consistent application and management across network functions.

A JSON message example for model update is shown as below, where a 3-layer neural network and 1-layer activation are formatted.

| | |
|---|---|
| { | |
| Layers:[ | |
| { | func:“linear”, |
| | nodes:[5, 128], |
| | weight_path:“/path” |
| | bias_path:“/path” |
| }, | |
| { | |
| | func:“linear”, |
| | nodes:[128, 128], |
| | weight_path:“/path”, |
| | bias_path:“/path” |
| }, | |
| { | |
| | func:“linear”, |
| | nodes:[128, 2], |
| | weight_path:“/path”, |
| | bias_path:“/path” |
| }, | |
| { | |
| | func:“relu” |
| }, | |
| ] | |
| } | |

In some examples, either shared-memory mode or interface mode, the contents may be organized as one JSON file.

Examples are not limited to the above-mentioned elements and process of FIG. 2.

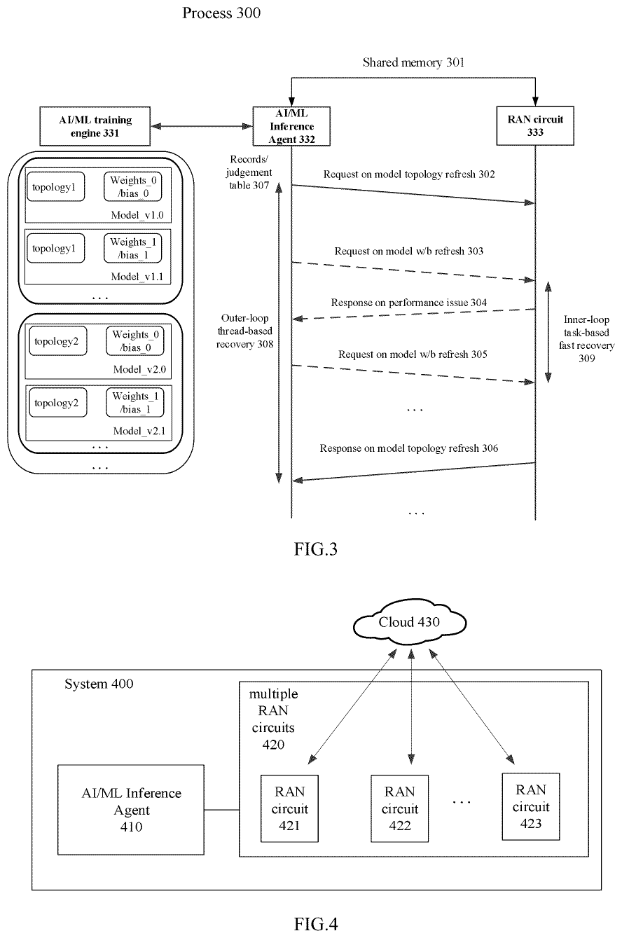

FIG. 3 is a schematic diagram illustrating an example process for inner-loop and outer-loop operations. In some examples, an example process 300 is shown in FIG. 3. The process 300 may be an example real-time process for model operations. As shown in FIG. 3, an AI/ML training engine 331, an AI/ML inference agent 332 and a RAN circuit 333 are illustrated. The AI/ML training engine 331 may be communicatively coupled to the AI/ML inference agent 332.

As shown in FIG. 3, the AI/ML inference agent 332 and the RAN circuit 333 may be in a shared-memory mode (shared memory 301). In the shared-memory mode, the AI/ML inference agent 332 and the RAN circuit 333 may access the same physical memory space via hardware-assisted mapping. They may communicate through memory-resident data structures and synchronize using atomic CPU instructions.

In some examples, the AI/ML inference agent 332 and the RAN circuit 333 may also be integrated in the system 100 shown in FIG. 1 or in the system 210 shown in FIG. 2.

In some examples, inner-loop operations may include AI/ML model inference and model update. However, there are cases where outer-loop solution is necessary. For example, in a case where the AI/ML inference agent 332 cannot maintain performance within the inner-loop. Thus, a fallback or backup decision may be made within the inner-loop without additional resources. The AI/ML inference agent 332 may execute the fallback or backup and trigger an outer-loop model refresh.

For example, when it is required to update model topology/parameters, outer computational resources are involved.

As shown in FIG. 3, in the process 300, the topology refresh may include topology modification, for example, layer, parameters, hyper-parameters. The outer resources may include multiple CPU-cores or other kinds of computing hardware/carrier, e.g., accelerated computing resource (s).

In some examples, the AI/ML inference agent 332 may initiate a first request on model topology refresh 302. Model topology update may be carried out in the outer-loop where different hardware may be involved. Then the AI/ML inference agent 332 awaits response from the RAN circuit 333.

In some examples, a fallback or backup may be executed by the AI/ML inference agent 332 when a first condition is met. The model fallback or backup may be based on inner-loop feedback. The feedback may include measurements, throughput, channel conditions, and so forth. The measurements may include predicted mutual information per bit (PMIB). The PMIB quantifies how much information a transmitted bit retains after battling noise, interference, and fading. Its scale runs from 0 (chaos) to 1 (perfect clarity). For example, the PMIB at a value of 0.7 means 70% of the bit's “soul” survives the channel's onslaught. The PMIB may illustrate the prediction performance of the AI/ML inference agent 332.

For example, the first condition may include the PMIB to fall below a predetermined threshold. When the PMIB fails to satisfy a threshold, a fallback or backup execution may be triggered. The AI/ML inference agent 332 may execute the model fallback or backup.

As shown in FIG. 3, the first inner-loop may include a request on model w/b (weight and bias) refresh 303 by the AI/ML inference agent 332 and a response on performance issue 304 by the RAN circuit 333. A second request on model weight and bias refresh (the request on model w/b refresh 303 as shown in FIG. 3) may be initiated. In the first inner-loop, the AI/ML inference agent 332 sends the second request to the RAN circuit 333. If there is a performance issue, for example, the PMIB falling below a predetermined threshold, the RAN circuit 333 may report the performance issue to the AI/ML inference agent 332 in the response on performance issue 304. In some examples, the AI/ML inference agent 332 monitors the PMIB and finds the PMIB to fall below a predetermined threshold. Then a fallback or backup decision is made by the AI/ML inference agent 332 within the first inner-loop. Consequently, a second inner-loop is triggered. The second inner-loop may include a request on model w/b (weight and bias) refresh 305 by the AI/ML inference agent 332. In the second inner-loop, the AI/ML inference agent 332 sends a third request on model weight and bias refresh (the request on model w/b refresh 305 as shown in FIG. 3) to the RAN circuit 333. The second inner-loop may include the operation 305 and a subsequent response from the RAN circuit 333.

In some examples, the inner-loops may operate iteratively. The number of inner-loops is not limited herein. Should the prediction performance metrics fail to meet predefined convergence criteria or a threshold, the loop initiates another computation cycle. This process repeats autonomously until the convergence criteria is met or the threshold is satisfied.

In some examples, the inner-loop may operate iteratively until the RAN circuit 333 judges the request may be fulfilled. The AI/ML records and judgement table 307 may be stored in the AI/ML inference agent 332. The requests and responses about the inner-loop and outer-loop operations may be recorded in a judgement table. The inner-loop task-based recovery 309 may include inner-loop operations 303, 304 and 305, as shown in FIG. 3.

If there is not any performance issue, for example, the PMIB being able to satisfy the threshold, the third request may be responded by the RAN circuit 333. Response to the third request may be sent to the AI/ML inference agent 332. Requests on model parameter refresh such as the second and third request are performed within the inner-loop. The inner-loop operations are task-based fast recovery operations.

In some examples, when the AI/ML inference agent 332 cannot maintain performance within the inner-loop, the AI/ML inference agent 332 executes fallback or backup and the outer-loop operations are performed. Model topology update may be carried out in the outer-loop where different hardware can be involved. The outer-loop operations may be thread-based, as multiple threads can be managed in a single thread scheduler in real-time. As shown in FIG. 3, in response to the first request (request on model topology refresh 302), a response on model topology refresh 306 is sent by the RAN circuit 333 to the AI/ML inference agent 332.

The requests and responses about the inner-loop and outer-loop operations may be recorded in a judgement table. The outer-loop thread-based recovery 308 may include outer-loop operations 302 and 306, as shown in FIG. 3.

As shown in FIG. 3, four example models in different versions are illustrated. The topology of the model_v1.0 may be topology 1, and the parameters of the model_v1.0 may include weights_0 and bias_0. The weights and bias of the model may be refreshed in the inner-loop. When operations such as 303, 304 and 305 are performed, the weight and bias of the model may be updated. For example, the weights_0 and bias_0 of the model_v1.0 may be updated to weights_1 and bias_1, where the topology of the model remains unchanged. Then the model_v1.1 may be obtained. Correspondingly, the weights_0 and bias_0 of the model_v2.0 may be updated to weights_1 and bias_1, where the topology of the model remains unchanged. Then the model_v2.1 may be obtained.

The model and the topology of the model may be refreshed in the outer-loop. When operations such as 302 and 306 are performed, the topology of the model may be refreshed. For example, the topology 1 of the model_v1.0 may be refreshed to topology 2, where the weights_0 and bias_0 of the model remain unchanged. Then the model_v2.0 may be obtained. Correspondingly, the topology 1 of the model_v2.0 may be refreshed to topology 2 where the weights_1 and bias_1 of the model remain unchanged. Then the model_v2.1 may be obtained. In some examples, model updates involving weight and bias parameter update are within an inner loop, where no outer computing resources are required from outside the mentioned hardware.

FIG. 4 is a schematic diagram illustrating another example system. As shown in FIG. 4, a cloud-based multi-RAN architecture is illustrated in a system 400. The system 400 may include an AI/ML inference agent 410, multiple RAN circuits 420 and a cloud 430. The RAN circuits 420 may be interconnected via the cloud 430. The RAN circuits 420 may include RAN circuit 421, RAN circuit 422, RAN circuit 423, and so forth. The number of circuits is not limited herein.

The RAN circuits 420 may be a software defined RAN. The AI/ML inference agent 410 may be a software defined AI/ML inference agent. The RAN circuits 420 may be a real-time RAN. The system 400 may be a real-time system integrating the AI/ML inference agent 410 and the RAN circuits 420. In some examples, the AI/ML inference agent 410 may be integrated in the RAN circuits 420.

Among the RAN circuits 420, a primary-auxiliary architecture may be implemented where the RAN circuits 420 may operate in a primary-auxiliary mode. In the primary-auxiliary mode, only one RAN circuit serves as the primary RAN circuit. One RAN circuit may act as a primary RAN, the other RAN circuits may act as auxiliary RANs. For example, when the RAN circuit 421 serves as the primary RAN, the other RAN circuits such as 422, 423 serve as the auxiliary RANs. This mode establishes a hierarchical compute fabric. In this mode, the auxiliary RANs serve as elastic compute extensions. The primary RAN may coordinate time-critical physical layer tasks. The auxiliary RANs may provide distributed computing resources and execute delegated sub-tasks under strict synchronization. For example, in the primary-auxiliary mode, the AI/ML inference agent 410 may designate the RAN circuit 421 as the primary RAN. The AI/ML inference agent 410 may designate the RAN circuit 422, RAN circuit 423, and others as the auxiliary RANs.

In some examples, the AI/ML inference agent 410 may aggregate resources from all the RAN circuits 420. The RAN circuits 420 may report real-time load to the AI/ML inference agent 410. The AI/ML inference agent 410 may shift idle resources from low-load RAN circuits to high-load circuits. For example, the RAN circuit 422 is the primary RAN. If the RAN circuit 422 has a high workload, while the auxiliary RAN circuit 421 and RAN circuit 423 have low workload, resources of the auxiliary RAN circuit 421 and RAN circuit 423 may be shifted by the AI/ML inference agent 410 to the primary RAN circuit 422. The AI/ML inference agent 410 may dynamically redistribute computing resources from underutilized RAN circuits to overloaded RAN circuits in real time. The compute utilization may be maximized. The wasted capacity may be eliminated.

In some examples, the AI/ML inference agent 410 may maintain a shared resource pool. This pool centralizes spare compute from all RAN circuits 420. The AI/ML inference agent 410 may monitor workloads of all RAN circuits 420 constantly. Once a traffic surge is detected in the primary RAN circuit by the AI/ML inference agent 410. The surge may include the workload of the primary RAN circuit exceeding pre-set thresholds (e.g., more than 80% CPU). The primary RAN circuit may send a request for emergency computing resources to the AI/ML inference agent 410. The AI/ML inference agent 410 may allocate resources from the pool to the primary RAN circuit. The allocation may be completed within milliseconds. After the surge, unused resources may be released automatically to the pool. The AI/ML inference agent 410 may reclaim resources to the pool. Dynamic allocation/reclamation of resources may be realized. These auxiliary RAN circuits may augment the primary RAN circuit's capacity, enabling seamless performance scaling without service disruption.

In some examples, one AI/ML inference agent 410 may be applied to multiple RAN circuits 420 (cells/entities). This may facilitate the flexibility of RAN deployment and enable the scalability of the system 400. One AI/ML inference agent 410 for multiple RAN circuits 420 may be lighter and faster in terms of expansion, upgrading, collaborative optimization and maintenance. For example, when there are numerous RAN circuits 420, the number of AI/ML inference agents 410 may increase exponentially, leading to complex deployment (each cell needs to configure a plurality of processes and interfaces for the AI/ML inference agents 410) and waste of resources (each agent occupies CPU/memory). Therefore, applying one AI/ML inference agent 410 to multiple RAN circuits 420 may provide centralized management and simplified deployment. Strategies of all the multiple RAN circuits 420 may be updated simply by updating one AI/ML inference agent 410 in cases such as a model topology update, a model fallback or backup, a strategy change, and so forth. Resource utilization may be significantly improved since each RAN circuit 420 no longer needs to occupy one agent. Besides, one AI/ML inference agent 410 for multiple RAN circuits 420 may facilitate deployments of different scales. For example, in a Flexible Radio Access Network (FlexRAN), depending on the resource utilization, the number of multiple RAN circuits 420 may be dynamically adjusted, where only the information of the multiple RAN circuits 420 needs to be connected or separated from the existing AI/ML inference agent 410 and there is no need to add or subtract any agents. Hardware used for compute may be shared between the AI/ML inference agent 410 and the RAN circuits 420. The hardware may include CPU cores. Computing tasks may be carried out within inner-loop in the system 400. The computing tasks may include model update, model fallback or backup, and so forth. Models may include machine learning models such as reinforcement learning models. In an inner-loop, only computing resources in the CPU domain are involved for compute. The system 400 may be deployed in the same set of CPU hardware as used for the inner-loop. Inner-loop refers to latency-critical computing tasks executed in RAN's physical layer, entirely consuming computing resources for real-time radio control. In some examples, the AI/ML inference agent 410 may host lightweight Machine Learning (ML) models locally for inner-loop tasks. The AI/ML inference agent 410 may embed lightweight models directly within the RAN circuits 420. The size of the model may be 1 MB and smaller. The model size can be dynamically adjusted according to the specific use environment. Performance of the model may be well justified on the reasonably sized models on CPU.

In some examples, the system 400 may be employed in the example process 200 for inner-loop operations as shown in FIG. 2. The AI/ML inference agent 410 and the RAN circuits 420 may be either in a shared-memory mode or in an interface mode. In the shared-memory mode, the AI/ML inference agent 410 and the RAN circuits 420 may access the same physical memory space via hardware-assisted mapping. They may communicate through memory-resident data structures and synchronize using atomic CPU instructions. In the interface mode, each of the RAN circuits 420 may be communicatively coupled to the AI/ML inference agent 410. All the RAN circuits 420 may be deployed in the cloud 430 where the circuits communicate with the cloud. The RAN circuits 420 may communicate with each other via the cloud-based network. In some examples, the AI/ML inference agent 410 may manage all RAN circuits 420 via one interface. The multi-RAN architecture may eliminate manual configs on individual RAN circuits 420.

Model operations may include model inference, model update, model fallback or backup. In some examples, the model update may include parameters (e.g., weights and bias) update. For example, when a model update is to be carried out in the system 400, resources for AI/ML model update are with the inner-loop based on CPU. Model update may use the same CPU resources set as RAN software workload. Inner-loop allows fast model modification, for example, the parameters modification. The inner-loop also allows multiple task-based operations in the CPU core. Only computing resources in the CPU domain are involved in updating the model parameter, where no outer computing resources are required from outside the CPU hardware.

In some examples, the model fallback or backup may be executed by the AI/ML inference agent 410 when a first condition is met. The model fallback or backup may be based on inner-loop feedback. The feedback may include measurements, throughput, channel conditions, and so forth. The measurements may include predicted mutual information per bit (PMIB). The PMIB quantifies how much information a transmitted bit retains after battling noise, interference, and fading. Its scale runs from 0 (chaos) to 1 (perfect clarity). For example, the PMIB at a value of 0.7 means 70% of the bit's “soul” survives the channel's onslaught. The PMIB may illustrate the prediction performance of the AI/ML inference agent 410.

For example, the first condition may include the PMIB to fall below a predetermined threshold. When the PMIB fails to satisfy a threshold, a fallback or backup execution may be triggered. The AI/ML inference agent 410 may execute the model fallback or backup. In a first inner-loop, the AI/ML inference agent 410 monitors the PMIB and finds the PMIB to fall below a predetermined threshold. Then a fallback or backup decision is made by the AI/ML inference agent 410 within the first inner-loop.

Consequently, a second inner-loop is triggered. In some examples, the inner-loops may operate iteratively, executing its computational routine while the AI/ML inference agent 410 monitors prediction performance metrics such as the PMIB. Should the prediction performance metrics fail to meet predefined convergence criteria or a threshold, the loop initiates another computation cycle. This process repeats autonomously until the convergence criteria is met or the threshold is satisfied. In some examples, the AI/ML inference agent 410 records on trained model, weights and bias version and performance evaluation criteria.

FIG. 5 is a schematic diagram illustrating yet another example system. A multi-RAN architecture is illustrated in a system 500 shown in FIG. 5. The system 500 may include an AI/ML inference agent 510, a plurality of RAN circuits 520, 531, 532, 533, and so forth. The RAN circuits 520 may be communicatively coupled to each other. Among the RAN circuits 520, 531, 532, 533 and others, an active-standby operational mode may be implemented. The number of circuits is not limited herein.

The RAN circuit 520 may be a software defined RAN. The AI/ML inference agent 510 may be a software defined AI/ML inference agent. The RAN circuit 520 may be a real-time RAN. The system 500 may be a real-time system integrating the AI/ML inference agent 510 and the RAN circuits 520, 531, 532, 533, and so forth. In some examples, the AI/ML inference agent 510 may be integrated in the RAN circuits 520, 531, 532, 533, and so forth.

In the active-standby mode, one RAN circuit may act as the active RAN, the other RAN circuits may act as standby RANs. For example, as shown in FIG. 5, the RAN circuit 520 serves as the active RAN, and the other RAN circuits such as 531, 532, 533 serve as the standby RANs. The active RAN 520 may act as an active workload handler during normal operation, while others remain on standby.

In some examples, if the active RAN becomes unavailable, one of the standby circuits will be configured as the active RAN circuit. For example, when the performance of the active RAN circuit 520 fails to meet predefined requirements (e.g., throughput thresholds or latency targets), the AI/ML inference agent 510 may dynamically designate one standby RAN circuit 531 as the active RAN circuit. The RAN circuit 520 may be designated as a standby RAN circuit. The AI/ML inference agent 510 may monitor the status of the RAN circuits and adaptively configures the circuits as active circuit or standby circuit. In the active-standby operational mode, active RAN circuit may be adaptively designated, facilitating the flexibility of RAN deployment. Once the active RAN circuit becomes standby, new resources from the new active RAN circuit may be integrated instantly.

In some examples, the system 500 may be employed in the example process 200 for inner-loop operations as shown in FIG. 2. The AI/ML inference agent 510 and the RAN circuits 520, 531, 532, 533, and others may be either in a shared-memory mode or in an interface mode. In the shared-memory mode, the AI/ML inference agent 510 and the RAN circuits 520, 531, 532, 533, and others may access the same physical memory space via hardware-assisted mapping. They may communicate through memory-resident data structures and synchronize using atomic CPU instructions. In the interface mode, each of the RAN circuits 520, 531, 532, 533, and others may be communicatively coupled to the AI/ML inference agent 510. In some examples, the AI/ML inference agent 510 may manage all RAN circuits 520, 531, 532, 533, and others via one interface. The multi-RAN architecture may eliminate manual configs on individual RAN circuits 520, 531, 532, 533, and so forth.

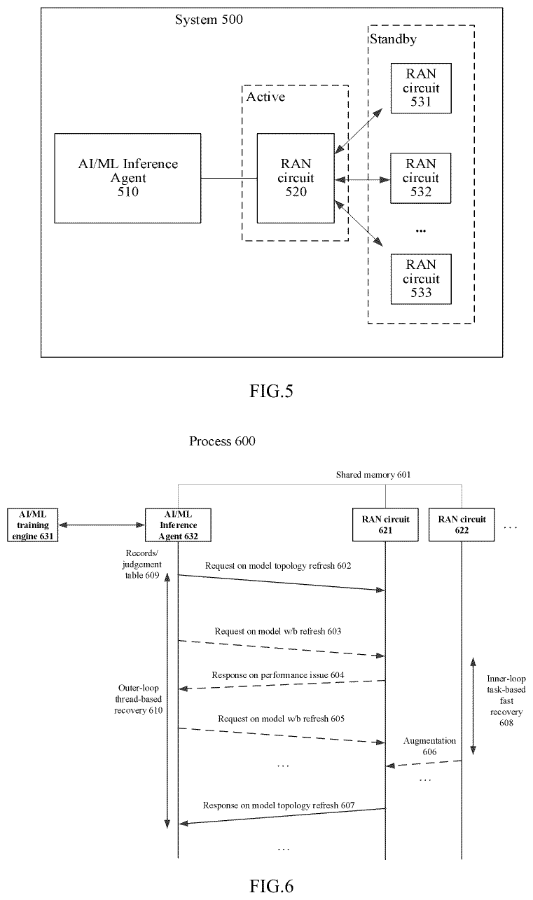

FIG. 6 is a schematic diagram illustrating another example process for inner-loop and outer-loop operations. In some examples, an example process 600 is shown in FIG. 6. The process 600 may be an example real-time process for model operations. As shown in FIG. 6, an AI/ML training engine 631, an AI/ML inference agent 632 and RAN circuits 621, 622 and others are illustrated. The AI/ML training engine 631 may be communicatively coupled to the AI/ML inference agent 632.

As shown in FIG. 6, the AI/ML inference agent 632 and the RAN circuits 621, 622 and others may be in a shared-memory mode (shared memory 601). In the shared-memory mode, the AI/ML inference agent 632 and the RAN circuits 621, 622 and others may access the same physical memory space via hardware-assisted mapping. They may communicate through memory-resident data structures and synchronize using atomic CPU instructions.

In some examples, the AI/ML inference agent 632 and the RAN circuits 621, 622 and others may also be integrated in the system 400 shown in FIG. 4 or in the system 500 shown in FIG. 5.

In some examples, inner-loop operations may include AI/ML model inference and model update. However, there are cases where outer-loop solution is necessary. For example, in a case where the AI/ML inference agent 632 cannot maintain performance within the inner-loop. Thus, a fallback or backup decision may be made within the inner-loop without additional resources. The AI/ML inference agent 632 may execute the fallback or backup and trigger an outer-loop model refresh.

For example, when it is required to update model topology/parameters, outer computational resources may be involved. The topology refresh may include topology modification, for example, layer, parameters, hyper-parameters. The outer resources may include multiple CPU-cores or other kinds of computing hardware/carrier, e.g., accelerated computing resource(s).

In some examples, the AI/ML inference agent 632 may initiate a first request on model topology refresh 602. Model topology update may be carried out in the outer-loop where different hardware may be involved. Then the AI/ML inference agent 632 awaits response from the RAN circuit 621.

In some examples, a fallback or backup may be executed by the AI/ML inference agent 632 when a first condition is met. The model fallback or backup may be based on inner-loop feedback. The feedback may include measurements, throughput, channel conditions, and so forth. The measurements may include predicted mutual information per bit (PMIB). The PMIB quantifies how much information a transmitted bit retains after battling noise, interference, and fading. Its scale runs from 0 (chaos) to 1 (perfect clarity). For example, the PMIB at a value of 0.7 means 70% of the bit's “soul” survives the channel's onslaught. The PMIB may illustrate the prediction performance of the AI/ML inference agent 632.

For example, the first condition may include the PMIB to fall below a predetermined threshold. When the PMIB fails to satisfy a threshold, a fallback or backup execution may be triggered. The AI/ML inference agent 632 may execute the model fallback or backup.

As shown in FIG. 6, the first inner-loop may include a request on model w/b (weight and bias) refresh 603 by the AI/ML inference agent 632 and a response on performance issue 604 by the RAN circuit 621. A second request on model weight and bias refresh (the request on model w/b refresh 603 as shown in FIG. 6) may be initiated. In the first inner-loop, the AI/ML inference agent 632 sends the second request to the RAN circuit 621. If there is a performance issue, for example, the PMIB falling below a predetermined threshold, the RAN circuit 621 may report the performance issue to the AI/ML inference agent 632 in the response on performance issue 604. In some examples, the AI/ML inference agent 632 monitors the PMIB and finds the PMIB to fall below a predetermined threshold. Then a fallback or backup decision is made by the AI/ML inference agent 632 within the first inner-loop. Consequently, since there is a reported issue, a second request on model w/b refresh is triggered. The second inner-loop may include a request on model w/b (weight and bias) refresh 605 by the AI/ML inference agent 632. In the second inner-loop, the AI/ML inference agent 632 sends a request on model weight and bias refresh (the request on model w/b refresh 605 as shown in FIG. 6) to the RAN circuit 621. Taking the primary-auxiliary mode as an example, since the RAN circuit 621 (serves as the primary RAN) cannot maintain performance within the first inner-loop, the resources of the auxiliary RAN circuit 622 may be shifted by the AI/ML inference agent 632 to the primary RAN circuit 621. These auxiliary RAN circuit 622 may provide augmentation 606 to the primary RAN circuit 621 for operations in the second inner-loop, accelerating the computation capacity of the primary RAN circuit 621. The second inner-loop may include operations 605, 606 and a subsequent response from the RAN circuit 621.

In some examples, the inner-loops may operate iteratively. The number of inner-loops or the augmentations is not limited herein. Should the prediction performance metrics fail to meet predefined convergence criteria or a threshold, the loop initiates another computation cycle. This process repeats autonomously until the convergence criteria is met or the threshold is satisfied.

The inner-loop may operate iteratively until the AI/ML inference agent 632 judges the request may be fulfilled. The AI/ML records and judgement table 609 may be stored in the AI/ML inference agent 632. The requests and responses about the inner-loop and outer-loop operations may be recorded in a judgement table. The inner-loop task-based recovery 608 may include inner-loop operations 603, 604, 605 and 606, as shown in FIG. 6.

If there is not any performance issue, for example, the PMIB being able to satisfy the threshold, the third request (the request on model w/b refresh 605) may be responded by the RAN circuits 621, 622, and so forth. Response to the third request may be sent to the AI/ML inference agent 632. Requests on model parameter refresh such as the second and third request are performed within the inner-loop. The inner-loop operations are task-based fast recovery operations.

In some examples, when the AI/ML inference agent 632 cannot maintain performance within the inner-loop, the AI/ML inference agent 632 executes fallback or backup and the outer-loop operations are performed. Model topology update may be carried out in the outer-loop where different hardware can be involved. The outer-loop operations may be thread-based, as multiple threads can be managed in a single thread scheduler in real-time. As shown in FIG. 6, in response to the first request (request on model topology refresh 602), a response on model topology refresh 607 is sent by the RAN circuits 621, 622, and so forth. to the AI/ML inference agent 632.

The requests and responses about the inner-loop and outer-loop operations may be recorded in a judgement table. The outer-loop thread-based recovery 610 may include outer-loop operations 602 and 607, as shown in FIG. 6.

When operations such as 603, 604, 605 and 606 are performed, the weight and bias of the model may be updated. For example, the weights_0 and bias_0 of the model_v1.0 may be updated to weights_1 and bias_1, where the topology of the model remains unchanged. Then the model_v1.1 may be obtained. Correspondingly, the weights_0 and bias_0 of the model_v2.0 may be updated to weights_1 and bias_1, where the topology of the model remains unchanged. Then the model_v2.1 may be obtained.

When operations such as 602 and 607 are performed, the topology of the model may be refreshed. For example, the topology 1 of the model_v1.0 may be refreshed to topology 2, where the weights_0 and bias_0 of the model remain unchanged. Then the model_v2.0 may be obtained. Correspondingly, the topology 1 of the model_v2.0. may be refreshed to topology 2 where the weights_1 and bias_1 of the model remain unchanged. Then the model_v2.1 may be obtained.

In some examples, model updates involving weight and bias parameter update are within an inner loop, where no outer computing resources are required from outside the mentioned hardware.

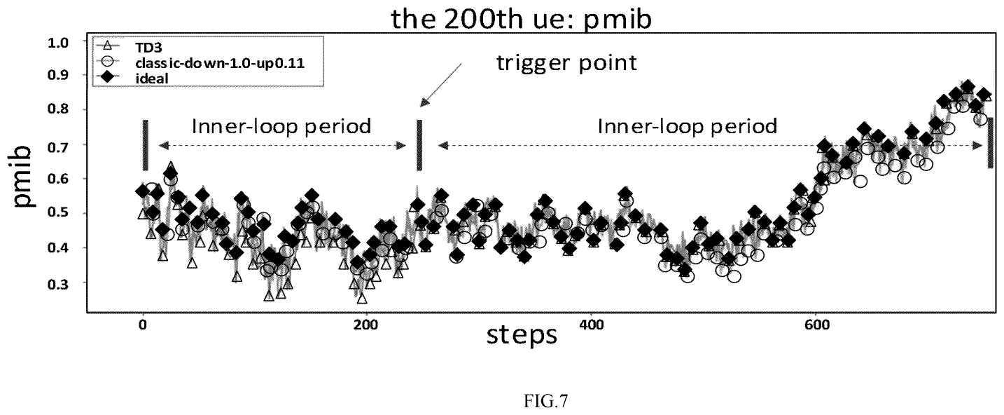

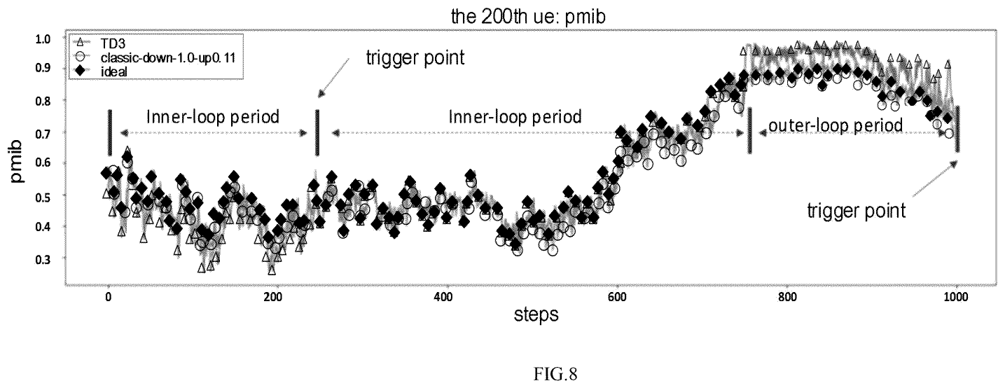

FIG. 7 is a schematic diagram illustrating an example workflow for inner-loop operations. The inner-loop operations may be carried out in a typical test environment for RAN system. The test environment may include a test UE and a system integrating an AI/ML inference agent and a RAN circuit, for example, the system 100 shown in FIG. 1, the system 400 shown in FIG. 4 or the system 500 shown in FIG. 5. The test may be carried out with the following assumptions. One UE is dropped in the test (eg., the id of the UE may be id 200). predicted mutual information per bit (PMIB) may be used for illustration of the prediction performance of the AI/ML inference agent.

As shown in FIG. 7, three sorts of curves are illustrated, including an ideal curve, a TD3 curve and a Classic-down-1.0-up0.11 curve. In FIG. 7, the vertical axis of the chart represents the PMIB values, and the horizontal axis of the chart represents the steps, which denote the sequence of iterations or stages in the test process. The horizontal axis may provide a temporal or sequential framework for tracking changes in performance. These steps could represent individual time intervals, so as to observe how the PMIB of each curve evolves over time.

The ideal curve may represent ideally converted mutual information from Signal to Interference plus Noise Ratio (SINR). The ideal curve may represent an ideal PMIB. The Signal-to-Interference-plus-Noise Ratio (SINR) is a crucial parameter in communication systems that measures the quality of a signal by comparing the power of the desired signal to the combined power of interference and noise.

The formula for SINR is

$$SINR = \frac{{P}_{S}}{{P}_{i} + {P}_{n}} ,$$

where P_{S} is the received signal power, Pᵢ is the interference power, and Pₙ is the noise power. Each of these quantities is typically measured in watts (W), which is the circuit of power. The received signal power P_{S} indicates the strength of the desired signal at the receiver, while the interference power Pᵢ accounts for the unwanted signals from other sources that can disrupt the desired signal. The noise power Pₙ represents the random fluctuations in the signal due to thermal noise or other sources of background noise. Since SINR is a ratio of powers, it is a dimensionless quantity, often expressed in decibels (dB).

The TD3 curve may represent a PMIB predicted by the AI/ML inference agent from CQI, BLER, HARQ, CQI offset. Channel Quality Indicator (CQI) is a metric used in wireless communication to report the quality of the wireless channel from the perspective of the receiver. It is typically reported by a UE to a base station. The CQI value indicates how well the channel is performing, taking into account factors such as signal strength, interference, and noise. Block Error Rate (BLER) is a measure of the reliability of data transmission in a wireless system. It is defined as the ratio of the number of transport blocks that are received with errors to the total number of transport blocks transmitted. Hybrid Automatic Repeat Request (HARQ) is a technique used in wireless communication systems to improve the reliability of data transmission. It combines the concepts of Automatic Repeat Request (ARQ) and Forward Error Correction (FEC). In HARQ, the receiver checks the received data for errors using error detection codes. If errors are detected, the receiver requests the sender to retransmit the data. CQI offset is a value that is used to adjust the reported CQI value. It can be applied by the network to compensate for various factors that might affect the accuracy of the CQI reported by the UE.

The Classic-down-1.0-up0.11 curve may represent a PMIB predicted by a classic algorithm with NACK adjustment-1.0 and ACK adjustment 0.11. Classic-down-1.0-up0.11 describes a classic algorithm that adjusts a parameter downward by 1.0 in response to a NACK and upward by 0.11 in response to an ACK. This mechanism is used to improve the reliability and efficiency of data transmission in wireless communication systems. In communication systems, Negative Acknowledgment (NACK) refers to a signal sent by a receiver to indicate that a transmitted message was not successfully received. In the context of “Classic-down-1.0”, it may indicate that when a NACK is received, the algorithm adjusts a certain parameter (such as transmission rate or power) downward by a factor of 1.0. Acknowledgment (ACK) is the opposite of NACK. An ACK signal indicates that a transmitted message was successfully received. The “up0.11” part means that when an ACK is received, the algorithm adjusts the same parameter upward by a factor of 0.11.

According to FIG. 7, two inner-loop periods are illustrated. The inner-loop periods may include a 1st inner-loop period and a 2nd inner-loop period.

In the 1st inner-loop period, there are obvious overlapping sections among these three curves, indicating that they share some similarities in their trajectories. Overall, the general trend of all three lines is consistent, suggesting a similar direction or pattern. However, the TD3 curve deviates noticeably from the ideal curve and the Classic-down-1.0-up0.11 curve, showing a clear discrepancy. This deviation indicates that the PMIB values associated with the TD3 curve are lower than that of the ideal curve and the Classic-down-1.0-up0.11 curve. Given the performance metrics illustrated, it is evident that further optimization is required. In this scenario, it is clear that proceeding to the next loop iteration would be necessary to refine the results and potentially improve the performance of the TD3 curve to align more closely with the ideal curve. The AI/ML inference agent may monitor and find the PMIB fall below a predetermined threshold. For example, the PMIB threshold may be 0.7. The PMIB of the TD3 curve remains below 0.7 in the 1st inner-loop period. Then a fallback or backup decision is made by the AI/ML inference agent and the AI/ML inference agent may execute the model fallback or backup. A 2nd round inner-loop model refresh may be triggered.

In the 2nd inner-loop period, the classic curve remains clearly distinguishable from the ideal curve, with a noticeable difference between them. Specifically, the PMIB value of the ideal curve is significantly higher than that of the classic curve. In contrast, the TD3 curve overlaps significantly with the ideal curve, to the extent that the TD3 curve is almost indistinguishable from the ideal curve. It is evident that during the 2nd inner-loop period, the TD3 curve overlaps almost completely with the ideal curve, indicating that the PMIB of the TD3 curve has approached the ideal condition. For example, the PMIB threshold may be 0.7. The PMIB of the TD3 curve remains below 0.7 in the 1st inner-loop period. In contrast, during the 2nd inner-loop period, at approximately 600 steps on the horizontal axis, the PMIB value reaches the threshold. After that, it fluctuates within a range of 0.1 above and below the threshold. At around 700 steps on the horizontal axis, the PMIB value exceeds the threshold.

It is evident that by employing the system integrating the AI/ML inference agent and the RAN circuit, the performance of the model is maintained. Moreover, the model updates within the inner-loop brings no additional cost since model updates uses the same CPU resources set as RAN software workload. fallback or backup decision is also within inner-loop without additional resources.

FIG. 8 is a schematic diagram illustrating an example workflow for inner-loop and outer-loop operations. The inner-loop operations may be carried out in a typical test environment for RAN system. The test environment may include a test UE and a system integrating an AI/ML inference agent and a RAN circuit, for example, the system 100 shown in FIG. 1, the system 400 shown in FIG. 4 or the system 500 shown in FIG. 5. The test may be carried out with the following assumptions. One UE is dropped in the test (eg., the id of the UE may be id 200).

As shown in FIG. 8, three sorts of curves are illustrated, including an ideal curve, a TD3 curve and a Classic-down-1.0-up0.11 curve. The interpretation and detailed description of these three curves are the same as those described in the previous example, and thus will not be reiterated here.

According to FIG. 8, two inner-loop periods and an outer-loop period are illustrated. The inner-loop periods may include a 1st inner-loop period, a 2nd inner-loop period. In the 1st inner-loop, the AI/ML inference agent may find the reported performance not able to reach the predetermined threshold (e.g., a PMIB threshold). For example, the PMIB threshold may be 0.7. The PMIB of the TD3 curve remains below 0.7 in the 1st inner-loop period. The 2nd round inner-loop model refresh is triggered. In a 2nd inner-loop period, the AI/ML inference agent monitors the 2nd inner-loop performance. For example, the PMIB threshold may be 0.7. The PMIB of the TD3 curve remains below 0.7 in the 1st inner-loop period. In contrast, during the 2nd inner-loop period, at approximately 600 steps on the horizontal axis, the PMIB value reaches the threshold. After that, it fluctuates within a range of 0.1 above and below the threshold. At around 700 steps on the horizontal axis, the PMIB value exceeds the threshold. At the end of the 2nd inner-loop period, an unexpected channel variance happens. Then an outer-loop is triggered. The AI/ML inference agent cannot maintain performance within the inner-loop, executing the fallback or backup and triggering the outer-loop model refresh.

During the outer-loop period, the classic curve remains clearly distinguishable from the ideal curve, with a noticeable difference between them. Specifically, the PMIB value of the ideal curve is significantly higher than that of the classic curve. However, the TD3 curve exhibits a very significant difference from the ideal curve, and it can be clearly seen that the PMIB values of the TD3 curve are higher than both the ideal curve and the classic curve.

Based on the descriptions in the previous examples, in some possible cases, after the outer-loop is executed, a subsequent inner-loop may be initiated when the performance reaches the threshold. For example, the PMIB threshold may be 0.7. As shown in FIG. 8, at around 1000 steps on the horizontal axis, the PMIB value of the TD3 curve almost drops down to nearly reach the threshold again, where another trigger point is also illustrated. Subsequently, the system may enter the next inner-loop.

In some examples, after the outer-loop is executed, a subsequent inner-loop may be initiated when a predetermined period has passed. The predetermined period may be 1000 steps. As shown in FIG. 8, at around 1000 steps on the horizontal axis, another trigger point is illustrated. Subsequently, the system may enter the next inner-loop.

The interpretation and detailed description of the inner-loop are the same as those described in the previously described process 200, 300 and thus will not be reiterated here.

In some examples, inner-loop may be operated locally. Outer-loop operations may be cloud-based.

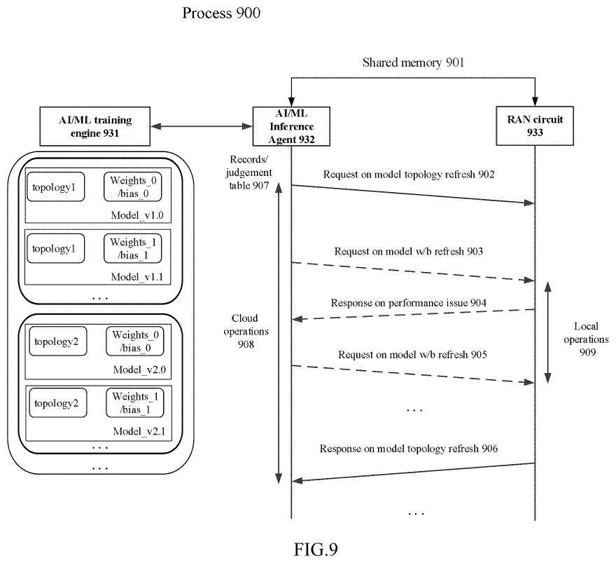

FIG. 9 is a schematic diagram illustrating an example process for local operations and cloud operations. In some examples, an example process 900 is shown in FIG. 9. The process 900 may be an example real-time process for model operations. As shown in FIG. 9, an AI/ML training engine 931, an AI/ML inference agent 932 and a RAN circuit 933 are illustrated. The AI/ML training engine 931 may be communicatively coupled to the AI/ML inference agent 932. The AI/ML inference agent 932 and the RAN circuit 933 may be in a shared-memory mode (shared memory 901). In the shared-memory mode 901, the AI/ML inference agent 932 and the RAN circuit 933 may access the same physical memory space via hardware-assisted mapping. They may communicate through memory-resident data structures and synchronize using atomic CPU instructions.

In some examples, the AI/ML inference agent 932 and the RAN circuit 933 may also be integrated in the system 100 shown in FIG. 1 or in the system 210 shown in FIG. 2.

In some examples, the local operations may include AI/ML model inference and model update. As shown in FIG. 9, the local operations 909 may include the operations 903, 904 and 905.

As shown in FIG. 9, the local operations may include more than one round of local operations. A first round of local operations may include a request on model w/b (weight and bias) refresh 903 by the AI/ML inference agent 932 and a response on performance issue 904 by the RAN circuit 933. In the first round of local operations, the AI/ML inference agent 932 sends the second request to the RAN circuit 933. If there is a performance issue, for example, the PMIB falling below a predetermined threshold. The RAN circuit 933 may report the performance issue to the AI/ML inference agent 932 in the response on performance issue 904. In some examples, the AI/ML inference agent 932 monitors the PMIB and finds the PMIB to fall below a predetermined threshold. Then a fallback or backup decision is made by the AI/ML inference agent 932 within the first round of local operations.

In some examples, a fallback or backup decision may be made by the AI/ML inference agent 932 when a first condition is met. The model fallback or backup may be based on feedback of the local operations. The feedback may include measurements, throughput, channel conditions, and so forth. The measurements may include predicted mutual information per bit (PMIB). The PMIB quantifies how much information a transmitted bit retains after battling noise, interference, and fading. Its scale runs from 0 (chaos) to 1 (perfect clarity). For example, the PMIB at a value of 0.7 means 70% of the bit's “soul” survives the channel's onslaught. The PMIB may illustrate the prediction performance of the AI/ML inference agent 932.

For example, the first condition may include the PMIB to fall below a predetermined threshold. When the PMIB fails to satisfy a threshold, a fallback or backup execution may be triggered. The AI/ML inference agent 932 may make a fallback or backup decision and execute the model fallback or backup.

Consequently, a second round of local operations is triggered. The second round of local operations may include a request on model w/b (weight and bias) refresh 905 by the AI/ML inference agent 932. In the second round of local operations, the AI/ML inference agent 932 sends a request on model weight and bias refresh 905 to the RAN circuit 933. The second round of local operations may include operations 905 and a subsequent response from the RAN circuit 933.

In some examples, the local operations may be performed iteratively. The number of rounds is not limited herein. Should the prediction performance metrics fail to meet predefined convergence criteria or a threshold, the local operations initiates another round of computation. This process repeats autonomously until the convergence criteria is met or the threshold is satisfied.

In some examples, the local operations may be performed iteratively until the RAN circuit 933 judges the request may be fulfilled. The AI/ML records and judgement table 907 may be stored in the AI/ML inference agent 932. The requests and responses about the local and cloud operations may be recorded in a judgement table. If there is not any performance issue, for example, the PMIB being able to satisfy the threshold, the request 905 may be responded by the RAN circuit 933. Response to the request 905 may be sent to the AI/ML inference agent 932. Requests on model parameter refresh such as the request 903 and the request 905 are performed within the local operations. The local operations 909 may be task-based fast recovery operations.

For cases where the AI/ML inference agent 932 cannot maintain performance within the local operations, cloud operations are necessary. Thus, cloud computational resources are required to be involved. When it is required to update model topology, the cloud operations may be involved. For example, a request on model topology refresh 902 is initiated by AI/ML inference agent 932. The AI/ML inference agent 932 cannot maintain performance within the local operations. A fallback or backup decision may be made by the AI/ML inference agent 932 within the local operations without additional resources. Then the AI/ML inference agent 932 may execute the fallback or backup and trigger cloud operations 908.

In some examples, the topology refresh may include topology modification, for example, layer, parameters, hyper-parameters. The cloud resources may include multiple CPU-cores or other kinds of computing hardware/carrier, e.g., accelerated computing resource.

As shown in FIG. 9, the cloud operations 908 may include the operations 902 and 906. After the AI/ML inference agent 932 initiates a first request on model topology refresh 902, model topology update may be carried out in the cloud operations where different hardware may be involved. Then the AI/ML inference agent 932 awaits response from the RAN circuit 933. As shown in FIG. 9, in response to the request on model topology refresh 902, a response on model topology refresh 906 is sent by the RAN circuit 933 to the AI/ML inference agent 932. The cloud operations 908 may be thread-based, as multiple threads can be managed in a single thread scheduler in real-time. The requests and responses about the local operations 909 and cloud operations 908 may be recorded in a judgement table.

As shown in FIG. 9, four example models in different versions are illustrated. The topology of the model_v1.0 may be topology 1, and the parameters of the model_v1.0 may include weights_0 and bias_0. The weights and bias of the model may be refreshed in the local operations. When operations such as 903, 904 and 905 are performed, the weight and bias of the model may be updated. For example, the weights_0 and bias_0 of the model_v1.0 may be updated to weights_1 and bias_1, where the topology of the model remains unchanged. Then the model_v1.1 may be obtained. Correspondingly, the weights_0 and bias_0 of the model_v2.0 may be updated to weights_1 and bias_1, where the topology of the model remains unchanged. Then the model_v2.1 may be obtained.

The model and the topology of the model may be refreshed in the cloud operations. When operations such as 902 and 906 are performed, the topology of the model may be refreshed. For example, the topology 1 of the model_v1.0 may be refreshed to topology 2, where the weights_0 and bias_0 of the model remain unchanged. Then the model_v2.0 may be obtained. Correspondingly, the topology 1 of the model_v2.0 may be refreshed to topology 2 where the weights_1 and bias_1 of the model remain unchanged. Then the model_v2.1 may be obtained. In some examples, model updates involving weight and bias parameter update are within the local operations, where no cloud computing resources are required from outside the mentioned hardware.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

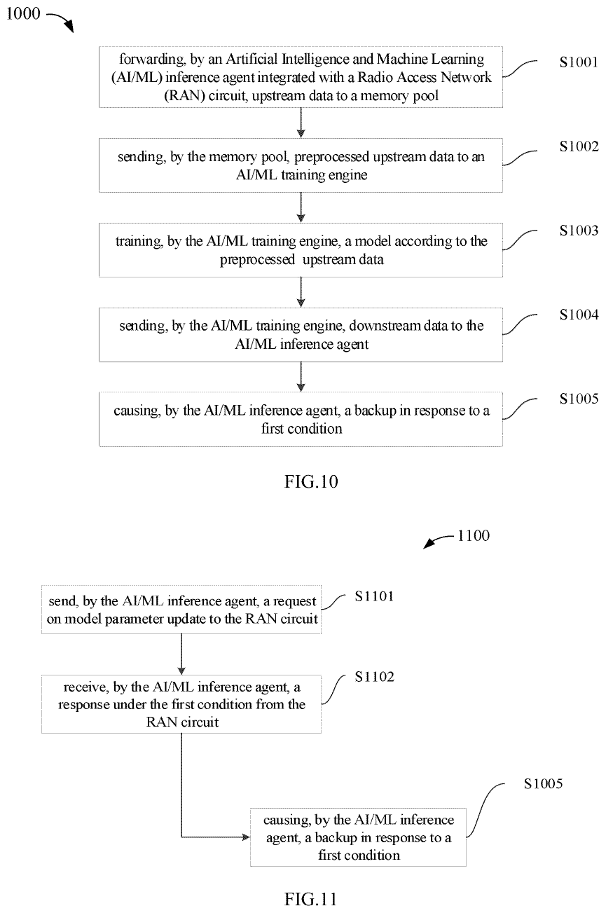

FIG. 10 illustrates an example logic flow 1000. The logic flow 1000 may be representative of some or all of the operations performed by a computing device. When a processing circuitry of the computing device executes a non-transitory computer-readable medium having instructions stored thereon, the computing device may perform operations included in the logic flow 1000.

According to some examples, the logic flow 1000 may include operations S1001, S1002, S1003, S1004 and S1005. In the operation S1001, an Artificial Intelligence and Machine Learning (AI/ML) inference agent, integrated with a Radio Access Network (RAN) circuit, may forward upstream data to a memory pool, the upstream data including information for inner-loop operations. In the operation S1002, the memory pool may send preprocessed upstream data to an AI/ML training engine. In the operation S1003, the AI/ML training engine may train a model according to the preprocessed upstream data. In the operation S1004, the AI/ML training engine may send downstream data to the AI/ML inference agent, where the downstream data may include feedback provided by the AI/ML training engine, where the feedback may include predicted mutual information per bit (PMIB) illustrating prediction performance of the AI/ML inference agent. In the operation S1005, the AI/ML inference agent may cause a backup in response to a first condition, where the first condition includes the PMIB to fall below a first predetermined PMIB threshold.

In some examples, prior to the operation S1005, where the AI/ML inference agent may cause the backup in response to the first condition, an example logic flow 1100 may be implemented. FIG. 11 illustrates another example of a logic flow. The logic flow 1100 may be representative of some or all of the operations performed by a computing device. When a processing circuitry of the computing device executes a non-transitory computer-readable medium having instructions stored thereon, the computing device may perform operations included in the logic flow 1100. According to some examples, the logic flow 1100 may include operations S1101 and S1102. In the operation S1101, the AI/ML inference agent may send a request on model parameter update to the RAN circuit. In the operation S1102, the AI/ML inference agent may receive a response under the first condition from the RAN circuit.

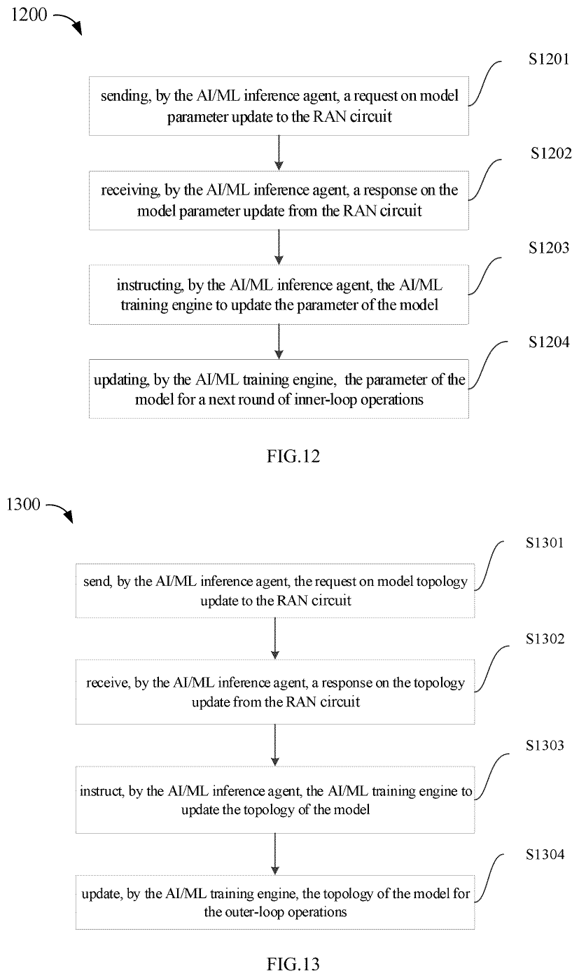

In some examples, the backup mentioned in the operation S1005 may include operations as shown in FIG. 12. FIG. 12 illustrates yet another example of a logic flow. In FIG. 12, an example logic flow 1200 may be implemented. The logic flow 1200 may be representative of some or all of the operations performed by a computing device. When a processing circuitry of the computing device executes a non-transitory computer-readable medium having instructions stored thereon, the computing device may perform operations included in the logic flow 1200. According to some examples, the logic flow 1200 may include operations S1201, S1202, S1203 and S1204. In the operation S1201, the AI/ML inference agent may send a request on model parameter update to the RAN circuit. In the operation S1202, the AI/ML inference agent may receive a response on the model parameter update from the RAN circuit. In the operation S1203, the AI/ML inference agent may instruct the AI/ML training engine to update the parameter of the model. In the operation S1204, the AI/ML training engine may update the parameter of the model for a next round of inner-loop operations.

In some examples, the downstream data may include a request for outer-loop operations to the system and the outer-loop operations may include model topology update. After the operation S1004, where the AI/ML training engine may send downstream data to the AI/ML inference agent, an example logic flow 1300 may be implemented. FIG. 13 illustrates an example of a logic flow. The logic flow 1300 may be representative of some or all of the operations performed by a computing device. When a processing circuitry of the computing device executes a non-transitory computer-readable medium having instructions stored thereon, the computing device may perform operations included in the logic flow 1300. According to some examples, the logic flow 1300 may include operations S1301, S1302, S1303 and S1304. In the operation S1301, the AI/ML inference agent may send the request on model topology update to the RAN circuit. In the operation S1302, the AI/ML inference agent may receive a response on the topology update from the RAN circuit. In the operation S1303, the AI/ML inference agent may instruct the AI/ML training engine to update the topology of the model. In the operation S1304, the AI/ML training engine may update the topology of the model for the outer-loop operations.

In some examples, prior to the operation 81302, further operations may be implemented. For example, the AI/ML training engine may update a parameter of the model for inner-loop operations, and the AI/ML inference agent may execute the backup until the PMIB reaches the first predetermined PMIB threshold.

In some examples, the AI/ML inference agent and the RAN circuit may be configured in a shared-memory mode or in an interface mode. Hardware used for computing may be shared between the AI/ML inference agent and the RAN circuit in the shared-memory mode, and the AI/ML inference agent and the RAN circuit are coupled to each other in the interface mode.

In some examples, after the operation 81304, further operations may be implemented. For example, the AI/ML inference agent may execute a subsequent inner-loop under a second condition, where the second condition includes the PMIB falling below a second predetermined PMIB threshold or a predetermined period has passed. In some examples, after the outer-loop is executed, a subsequent inner-loop may be initiated when the performance reaches the threshold. For example, the PMIB threshold may be 0.7 as shown in FIG. 8. In some examples, after the outer-loop is executed, a subsequent inner-loop may be initiated when a predetermined period has passed. For example, as shown in FIG. 8, the predetermined period may be 1000 steps. At around 1000 steps on the horizontal axis, another trigger point is illustrated. Subsequently, the system may enter the next inner-loop.

In some examples, prior to the operation S1002, further operations may be implemented. For example, the memory pool may allocate a buffer for performing preprocessing on the upstream data. The AI/ML training engine may analyze the preprocessed upstream data. The AI/ML training engine may prepare for training the model according to the analyzed upstream data, where training the model includes performing confidence evaluation and tuning on the model.

One or more aspects of at least one example may be implemented by representative instructions stored on at least one machine-readable medium which represents various logic within the processor. These instructions, when read by a machine, computing device or system causes the machine, computing device or system to fabricate logic to perform the techniques described herein. Such representations, known as “IP cores”, may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor devices, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. The choice of whether an example is implemented using hardware elements, software elements, or a combination thereof may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or rewriteable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language and syntax to instruct a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled” or the phrase “coupled with”, however, may also mean that two or more elements are not in direct contact with each other, but yet still cooperate or interact with each other.

The following examples pertain to various techniques of the present disclosure.

Example 1 is a system comprising: one or more processors; and one or more non-transitory computer-readable media storing instructions that, when executed by the one or more processors, cause the one or more processors to: forward, using an Artificial Intelligence and Machine Learning (AI/ML) inference agent integrated with a Radio Access Network (RAN) circuit, upstream data to a memory pool, wherein the upstream data comprises information for inner-loop operations; send, using the memory pool, preprocessed upstream data to an AI/ML training engine; train, using the AI/ML training engine, a model according to the preprocessed upstream data; send, using the AI/ML training engine, downstream data to the AI/ML inference agent, the downstream data comprising feedback provided by the AI/ML training engine, the feedback including predicted mutual information per bit (PMIB) corresponding to prediction performance of the AI/ML inference agent; and cause, using the AI/ML inference agent, a backup in response to a first condition, wherein the first condition includes the PMIB to fall below a first predetermined PMIB threshold.

Example 2 includes the subject matter of example 1, wherein the one or more processors are further configured to: send, using the AI/ML inference agent, a request on model parameter update to the RAN circuit; and receive, using the AI/ML inference agent, a response under the first condition from the RAN circuit.

Example 3 includes the subject matter of example 1, wherein the backup includes: sending, using the AI/ML inference agent, a request on model parameter update to the RAN circuit; receiving, using the AI/ML inference agent, a response on the model parameter update from the RAN circuit; instructing, using the AI/ML inference agent, the AI/ML training engine to update the parameter of the model; and updating, using the AI/ML training engine, the parameter of the model for a next round of inner-loop operations.

Example 4 includes the subject matter of example 1, wherein the downstream data includes a request for outer-loop operations and the outer-loop operations include model topology update, and wherein the one or more processors are further configured to: send, using the AI/ML inference agent, the request on model topology update to the RAN circuit; receive, using the AI/ML inference agent, a response on the topology update from the RAN circuit; instruct, using the AI/ML inference agent, the AI/ML training engine to update the topology of the model; and update, using the AI/ML training engine, the topology of the model for the outer-loop operations.

Example 5 includes the subject matter of example 4, wherein the one or more processors are further configured to: update, using the AI/ML training engine, a parameter of the model for inner-loop operations; and execute, using the AI/ML inference agent, the backup until the PMIB reaches the first predetermined PMIB threshold.

Example 6 includes the subject matter of example 1, wherein the AI/ML inference agent and the RAN circuit are configured in a shared-memory mode or in an interface mode; and wherein hardware used for computing is shared between the AI/ML inference agent and the RAN circuit in the shared-memory mode, and the AI/ML inference agent and the RAN circuit are coupled to each other in the interface mode.

Example 7 includes the subject matter of example 4, wherein the one or more processors are further configured to: execute, using the AI/ML inference agent, a subsequent inner-loop under a second condition, wherein the second condition includes the PMIB to fall below a second predetermined PMIB threshold or a predetermined period has passed.

Example 8 includes the subject matter of example 1, wherein the one or more processors are further configured to: allocate, using the memory pool, a buffer for performing preprocessing on the upstream data; analyze, using the AI/ML training engine, the preprocessed upstream data; and prepare, using the AI/ML training engine, for training the model according to the analyzed upstream data, wherein training the model includes performing confidence evaluation and tuning on the model.

Example 9 is a non-transitory computer-readable medium having instructions stored thereon, that when executed by processing circuitry of a computing device, cause the computing device to perform operations, including: forwarding, by an AI/ML inference agent integrated with a RAN circuit, upstream data to a memory pool, wherein the upstream data includes information for inner-loop operations; sending, by the memory pool, preprocessed upstream data to an AI/ML training engine; training, by the AI/ML training engine, a model according to the preprocessed upstream data; sending, by the AI/ML training engine, downstream data to the AI/ML inference agent, the downstream data including feedback provided by the AI/ML training engine, the feedback including PMIB corresponding to prediction performance of the AI/ML inference agent; and cause, by the AI/ML inference agent, a backup in response to a first condition, wherein the first condition includes the PMIB to fall below a first predetermined PMIB threshold.

Example 10 includes the subject matter of example 9, further including instructions that when executed by processing circuitry of the computing device, cause the computing device, prior to the AI/ML inference agent causing the backup, to: send, by the AI/ML inference agent, a request on model parameter update to the RAN circuit; and receive, by the AI/ML inference agent, a response under the first condition from the RAN circuit.

Example 11 includes the subject matter of example 9, wherein the backup includes: sending, by the AI/ML inference agent, a request on model parameter update to the RAN circuit; receiving, by the AI/ML inference agent, a response on the model parameter update from the RAN circuit; instructing, by the AI/ML inference agent, the AI/ML training engine to update the parameter of the model; and updating, by the AI/ML training engine, the parameter of the model for a next round of inner-loop operations.

Example 12 includes the subject matter of example 9, wherein the downstream data includes a request for outer-loop operations and the outer-loop operations include model topology update, and wherein the non-transitory computer-readable medium further includes instructions that when executed by processing circuitry of the computing device, cause the computing device, after the AI/ML training engine sends the downstream data to the AI/ML inference agent, to: send, by the AI/ML inference agent, the request on model topology update to the RAN circuit; receive, by the AI/ML inference agent, a response on the topology update from the RAN circuit; instruct, by the AI/ML inference agent, the AI/ML training engine to update the topology of the model; and update, by the AI/ML training engine, the topology of the model for the outer-loop operations.

Example 13 includes the subject matter of example 12, further including instructions that when executed by processing circuitry of the computing device, cause the computing device, prior to the AI/ML inference agent receiving the response on the topology update from the RAN circuit, to: update, by the AI/ML training engine, a parameter of the model for inner-loop operations; and execute, by the AI/ML inference agent, the backup until the PMIB reaches the first predetermined PMIB threshold.

Example 14 includes the subject matter of example 9, wherein the AI/ML inference agent and the RAN circuit are configured in a shared-memory mode or in an interface mode; and wherein hardware used for computing is shared between the AI/ML inference agent and the RAN circuit in the shared-memory mode, and the AI/ML inference agent and the RAN circuit are coupled to each other in the interface mode.

Example 15 includes the subject matter of example 12, further including instructions that when executed by processing circuitry of the computing device, cause the computing device, after the AI/ML training engine updates the topology of the model for the outer-loop operations, to: execute, by the AI/ML inference agent, a subsequent inner-loop under a second condition, wherein the second condition includes the PMIB to fall below a second predetermined PMIB threshold or a predetermined period has passed.

Example 16 includes the subject matter of example 9, further including instructions that when executed by processing circuitry of the computing device, cause the computing device, prior to the memory pool sending the preprocessed upstream data to the AI/ML training engine, to: allocate, by the memory pool, a buffer for performing preprocessing on the upstream data; analyze, by the AI/ML training engine, the preprocessed upstream data; and prepare, by the AI/ML training engine, for training the model according to the analyzed upstream data, wherein training the model includes performing confidence evaluation and tuning on the model.

Example 17 is a method, including: forwarding, by an AI/ML inference agent integrated with a RAN circuit, upstream data to a memory pool, wherein the upstream data includes information for inner-loop operations; sending, by the memory pool, preprocessed upstream data to an AI/ML training engine; training, by the AI/ML training engine, a model according to the preprocessed upstream data; sending, by the AI/ML training engine, downstream data to the AI/ML inference agent, the downstream data including feedback provided by the AI/ML training engine, the feedback including PMIB corresponding to prediction performance of the AI/ML inference agent; and causing, by the AI/ML inference agent, a backup in response to a first condition, wherein the first condition includes the PMIB to fall below a first predetermined PMIB threshold.

Example 18 includes the subject matter of example 17, the method, prior to the AI/ML inference agent causing the backup, further includes: sending, by the AI/ML inference agent, a request on model parameter update to the RAN circuit; and receiving, by the AI/ML inference agent, a response under the first condition from the RAN circuit.

Example 19 includes the subject matter of example 17 or 18, wherein the backup includes: sending, by the AI/ML inference agent, a request on model parameter update to the RAN circuit; receiving, by the AI/ML inference agent, a response on the model parameter update from the RAN circuit; instructing, by the AI/ML inference agent, the AI/ML training engine to update the parameter of the model; and updating, by the AI/ML training engine, the parameter of the model for a next round of inner-loop operations.

Example 20 includes the subject matter of any one of examples 17 to 19, wherein the downstream data includes a request for outer-loop operations and the outer-loop operations include model topology update, and wherein the method, after the AI/ML training engine sends the downstream data to the AI/ML inference agent, further includes: sending, by the AI/ML inference agent, the request on model topology update to the RAN circuit; receiving, by the AI/ML inference agent, a response on the topology update from the RAN circuit; instructing, by the AI/ML inference agent, the AI/ML training engine to update the topology of the model; and updating, by the AI/ML training engine, the topology of the model for the outer-loop operations.

Example 21 includes the subject matter of any one of examples 17 to 20, wherein the method, prior to the AI/ML inference agent receiving the response on the topology update from the RAN circuit, further includes: updating, by the AI/ML training engine, a parameter of the model for inner-loop operations; and executing, by the AI/ML inference agent, the backup until the PMIB reaches the first predetermined PMIB threshold.

Example 22 includes the subject matter of any one of examples 17 to 21, wherein the AI/ML inference agent and the RAN circuit are configured in a shared-memory mode or in an interface mode; and wherein hardware used for computing is shared between the AI/ML inference agent and the RAN circuit in the shared-memory mode, and the AI/ML inference agent and the RAN circuit are coupled to each other in the interface mode.

Example 23 includes the subject matter of any one of examples 17 to 22, wherein the method, after the AI/ML training engine updates the topology of the model for the outer-loop operations, further includes: executing, by the AI/ML inference agent, a subsequent inner-loop under a second condition, wherein the second condition includes the PMIB to fall below a second predetermined PMIB threshold or a predetermined period has passed.

Example 24 includes the subject matter of any one of examples 17 to 23, wherein the method, prior to the memory pool sending the preprocessed upstream data to the AI/ML training engine, further includes: allocating, by the memory pool, a buffer for performing preprocessing on the upstream data; analyzing, by the AI/ML training engine, the preprocessed upstream data; and preparing, by the AI/ML training engine, for training the model according to the analyzed upstream data, wherein training the model includes performing confidence evaluation and tuning on the model.

Example 25 is one or more computer-readable media storing instructions which, when executed by one or more processors, cause the one or more processors to perform the subject matter of any one of examples 17 to 24.

Example 26 is a computing apparatus including means for performing the subject matter of any one of examples 17 to 24.

Example 27 is a computer program product including instructions which, when executed by one or more processors, cause the one or more processors to perform the subject matter of any one of examples 17 to 24.

Example 28 is a computer program including instructions which, when executed by one or more processors, cause the one or more processors to perform the subject matter of any one of examples 17 to 24.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system comprising:
one or more processors; and
one or more non-transitory computer-readable media storing instructions that, when executed by the one or more processors, cause the one or more processors to:
forward, using an Artificial Intelligence and Machine Learning (AI/ML) inference agent integrated with a Radio Access Network (RAN) circuit, upstream data to a memory pool, wherein the upstream data comprises information for inner-loop operations;
send, using the memory pool, preprocessed upstream data to an AI/ML training engine;
train, using the AI/ML training engine, a model according to the preprocessed upstream data;
send, using the AI/ML training engine, downstream data to the AI/ML inference agent, the downstream data comprising feedback provided by the AI/ML training engine, the feedback comprising predicted mutual information per bit (PMIB) corresponding to prediction performance of the AI/ML inference agent; and
cause, using the AI/ML inference agent, a backup in response to a first condition, wherein the first condition comprises the PMIB to fall below a first predetermined PMIB threshold.

2. The system of claim 1, wherein the one or more processors are further configured to:
send, using the AI/ML inference agent, a request on model parameter update to the RAN circuit; and
receive, using the AI/ML inference agent, a response under the first condition from the RAN circuit.

3. The system of claim 1, wherein the backup comprises:
send, using the AI/ML inference agent, a request on model parameter update to the RAN circuit;
receive, using the AI/ML inference agent, a response on the model parameter update from the RAN circuit;
instruct, using the AI/ML inference agent, the AI/ML training engine to update the parameter of the model; and
update, using the AI/ML training engine, the parameter of the model for a next round of inner-loop operations.

4. The system of claim 1, wherein the downstream data comprises a request for outer-loop operations and the outer-loop operations comprise model topology update, and wherein the one or more processors are further configured to:
send, using the AI/ML inference agent, the request on model topology update to the RAN circuit;
receive, using the AI/ML inference agent, a response on the topology update from the RAN circuit;
instruct, using the AI/ML inference agent, the AI/ML training engine to update the topology of the model; and
update, using the AI/ML training engine, the topology of the model for the outer-loop operations.

5. The system of claim 4, wherein the one or more processors are further configured to:
update, using the AI/ML training engine, a parameter of the model for inner-loop operations; and
execute, using the AI/ML inference agent, the backup until the PMIB reaches the first predetermined PMIB threshold.

6. The system of claim 1, wherein the AI/ML inference agent and the RAN circuit are configured in a shared-memory mode or in an interface mode; and
wherein hardware used for computing is shared between the AI/ML inference agent and the RAN circuit in the shared-memory mode, and the AI/ML inference agent and the RAN circuit are coupled to each other in the interface mode.

7. The system of claim 4, wherein the one or more processors are further configured to:
execute, using the AI/ML inference agent, a subsequent inner-loop under a second condition, wherein the second condition comprises the PMIB to fall below a second predetermined PMIB threshold or a predetermined period has passed.

8. The system of claim 1, wherein the one or more processors are further configured to:
allocate, using the memory pool, a buffer for performing preprocessing on the upstream data;
analyze, using the AI/ML training engine, the preprocessed upstream data; and
prepare, using the AI/ML training engine, for training the model according to the analyzed upstream data, wherein training the model comprises performing confidence evaluation and tuning on the model.

9. At least one non-transitory computer-readable medium having instructions stored thereon, that when executed by processing circuitry of a computing device, cause the computing device to perform operations, comprising:
forwarding, by an AI/ML inference agent integrated with a RAN circuit, upstream data to a memory pool, wherein the upstream data comprises information for inner-loop operations;
sending, by the memory pool, preprocessed upstream data to an AI/ML training engine;
training, by the AI/ML training engine, a model according to the preprocessed upstream data;
sending, by the AI/ML training engine, downstream data to the AI/ML inference agent, the downstream data comprising feedback provided by the AI/ML training engine, the feedback comprising PMIB corresponding to prediction performance of the AI/ML inference agent; and
cause, by the AI/ML inference agent, a backup in response to a first condition, wherein the first condition comprises the PMIB to fall below a first predetermined PMIB threshold.

10. The non-transitory computer-readable medium of claim 9, further comprising instructions that when executed by processing circuitry of the computing device, cause the computing device, prior to the AI/ML inference agent causing the backup, to:
send, by the AI/ML inference agent, a request on model parameter update to the RAN circuit; and
receive, by the AI/ML inference agent, a response under the first condition from the RAN circuit.

11. The non-transitory computer-readable medium of claim 9, wherein the backup comprises:
sending, by the AI/ML inference agent, a request on model parameter update to the RAN circuit;
receiving, by the AI/ML inference agent, a response on the model parameter update from the RAN circuit;
instructing, by the AI/ML inference agent, the AI/ML training engine to update the parameter of the model; and
updating, by the AI/ML training engine, the parameter of the model for a next round of inner-loop operations.

12. The non-transitory computer-readable medium of claim 9, wherein the downstream data comprises a request for outer-loop operations and the outer-loop operations comprise model topology update, and wherein the non-transitory computer-readable medium further comprises instructions that when executed by processing circuitry of the computing device, cause the computing device, after the AI/ML training engine sends the downstream data to the AI/ML inference agent, to:
send, by the AI/ML inference agent, the request on model topology update to the RAN circuit;
receive, by the AI/ML inference agent, a response on the topology update from the RAN circuit;
instruct, by the AI/ML inference agent, the AI/ML training engine to update the topology of the model; and
update, by the AI/ML training engine, the topology of the model for the outer-loop operations.

13. The non-transitory computer-readable medium of claim 12, further comprising instructions that when executed by processing circuitry of the computing device, cause the computing device, prior to the AI/ML inference agent receiving the response on the topology update from the RAN circuit, to:
update, by the AI/ML training engine, a parameter of the model for inner-loop operations; and
execute, by the AI/ML inference agent, the backup until the PMIB reaches the first predetermined PMIB threshold.

14. The non-transitory computer-readable medium of claim 9, wherein the AI/ML inference agent and the RAN circuit are configured in a shared-memory mode or in an interface mode; and
wherein hardware used for computing is shared between the AI/ML inference agent and the RAN circuit in the shared-memory mode, and the AI/ML inference agent and the RAN circuit are coupled to each other in the interface mode.

15. The non-transitory computer-readable medium of claim 12, further comprising instructions that when executed by processing circuitry of the computing device, cause the computing device, after the AI/ML training engine updates the topology of the model for the outer-loop operations, to:
execute, by the AI/ML inference agent, a subsequent inner-loop under a second condition, wherein the second condition comprises the PMIB to fall below a second predetermined PMIB threshold or a predetermined period has passed.

16. The non-transitory computer-readable medium of claim 9, further comprising instructions that when executed by processing circuitry of the computing device, cause the computing device, prior to the memory pool sending the preprocessed upstream data to the AI/ML training engine, to:
allocate, by the memory pool, a buffer for performing preprocessing on the upstream data;
analyze, by the AI/ML training engine, the preprocessed upstream data; and
prepare, by the AI/ML training engine, for training the model according to the analyzed upstream data, wherein training the model comprises performing confidence evaluation and tuning on the model.

17. A method, comprising:
forwarding, by an AI/ML inference agent integrated with a RAN circuit, upstream data to a memory pool, wherein the upstream data comprises information for inner-loop operations;
sending, by the memory pool, preprocessed upstream data to an AI/ML training engine;
training, by the AI/ML training engine, a model according to the preprocessed upstream data;
sending, by the AI/ML training engine, downstream data to the AI/ML inference agent, the downstream data comprising feedback provided by the AI/ML training engine, the feedback comprising PMIB corresponding to prediction performance of the AI/ML inference agent; and
causing, by the AI/ML inference agent, a backup in response to a first condition, wherein the first condition comprises the PMIB to fall below a first predetermined PMIB threshold.

18. The method of claim 17, wherein the method, prior to the AI/ML inference agent causing the backup, further comprises:
sending, by the AI/ML inference agent, a request on model parameter update to the RAN circuit; and
receiving, by the AI/ML inference agent, a response under the first condition from the RAN circuit.

19. The method of claim 17, wherein the backup comprises:
sending, by the AI/ML inference agent, a request on model parameter update to the RAN circuit;
receiving, by the AI/ML inference agent, a response on the model parameter update from the RAN circuit;
instructing, by the AI/ML inference agent, the AI/ML training engine to update the parameter of the model; and
updating, by the AI/ML training engine, the parameter of the model for a next round of inner-loop operations.

20. The method of claim 17, wherein the downstream data comprises a request for outer-loop operations and the outer-loop operations comprise model topology update, and wherein the method, after the AI/ML training engine sends the downstream data to the AI/ML inference agent, further comprises:
sending, by the AI/ML inference agent, the request on model topology update to the RAN circuit;
receiving, by the AI/ML inference agent, a response on the topology update from the RAN circuit;
instructing, by the AI/ML inference agent, the AI/ML training engine to update the topology of the model; and
updating, by the AI/ML training engine, the topology of the model for the outer-loop operations.
